(19) United States
(12) Patent Application Publication
(10) Pub. No.: US 2015/0155600 A1
(43) Pub. Date: Jun. 4, 2015

(54) ELECTROLYTIC COMPOSITION COMPRISING A COORDINATION COMPOUND INCLUDING LITHIUM AND AT LEAST ONE LIGAND OF THE TRIFLUOROMETHYLPHENATE TYPE

(71) Applicant: Commissariat a I'energie atomique et aux energies alternatives, Pairs (FR)

(72) Inventors: Herve Galiano, La Ville Aux Dames (FR); Stephane Cadra, Saint Avertin (FR); Jerome Thibonnet, Veigne (FR); Daniel Lemordant, Vouvray (FR)

(21) Appl. No.: 14/405,375

(22) PCT Filed: Jun. 7, 2013
(86) PCT No.: PCT/EP2013/061814

§ 371 Date: Dec. 3, 2014

(30) Foreign Application Priority Data
Jun. 7, 2012 (FR) 1255317

(51) Int. Cl. H01M 10/0569; H01M 10/0525

(52) U.S. Cl. CPC H01M 10/0569; H01M 10/0525

(57) ABSTRACT

The invention relates to electrolytic compositions comprising:
at least one coordination complex comprising lithium and one or several ligands thereof, this (these) ligand(s) corresponding to a phenate compound comprising at least one trifluoromethyl group; and
at least one carbonate solvent.

### TECHNICAL FIELD

The present invention relates to novel electrolytic compositions comprising at least one coordination complex comprising lithium and at least one ligand of the trifluoromethylphenate type, these novel compositions finding application in the field of electrolytes, more particularly in electrolytes of lithium-ion batteries.

One of the general fields may therefore be defined as that of lithium-ion batteries.

### STATE OF THE PRIOR ART

From a functional point of view, lithium-ion batteries are based on the principle of intercalation-deintercalation of the lithium within the constitutive materials of the electrodes of electrochemical cells of the battery.

More specifically, the reaction at the origin of the production of current (i.e., when the battery is in a discharge mode) puts into play the transfer, via an electrolyte conducting lithium ions, of lithium cations from a negative electrode which will be intercalated into the acceptor lattice of the positive electrode, while electrons from the reaction at the negative electrode will supply the outer circuit, to which are connected the positive and negative electrode.

These electrolytes may consist in a mixture comprising at least one organic solvent and at least one lithium salt for ensuring conduction of said lithium ions, which requires that the lithium salt be dissolved in said organic solvent.

Considering what already exists, the inventors of the present invention propose to develop novel electrolytic compositions conducting lithium ions, not requiring resorting to lithium salt dissolved in an organic solvent, and which are simple to manufacture.

### DISCUSSION OF THE INVENTION

The invention thus relates to an electrolytic composition comprising:
at least one coordination complex comprising lithium and one or several ligands thereof, this (these) ligand(s) corresponding to a phenate compound comprising at least one trifluoromethyl group; and
at least one carbonate solvent.

In the sense of the invention, by ligand is meant a compound able to share with the lithium atom a negative charge or an electron doublet so as to form a coordination bond.

The aforementioned phenate compound fulfilling the ligand function may be a phenate compound fitting the following formula (I):

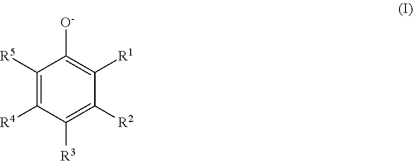

wherein at least one of the R¹ to R⁵ represents a trifluoromethyl group, while the other groups, when they do not all represent a trifluoromethyl group, represent a hydrogen atom.

More specifically, said compound may be a 3-trifluoromethylphenate compound, a 3,5-bis(trifluoromethyl)phenate compound or a 2,4,6-tris(trifluoromethyl)phenate.

In addition to the aforementioned ligand(s), the complexes present in the compositions of the invention may comprise a compound belonging to the family of ethers. In this case, an oxygen atom belonging to this compound is bound to lithium element(s) via a coordination bond.

This compound belonging to the family of ethers may fit the following general formula (II):

R—O—R′ (II)

wherein R and R′ represent, independently of each other, a hydrocarbon group advantageously comprising from 2 to 4 carbon atoms. More specifically, this may be an alkyl group comprising from 2 to 4 carbon atoms. In particular, this may be an ethyl group, in which case the ether compound is diethyl ether.

Specific complexes may be present in the compositions of the invention fitting the following formula (III):

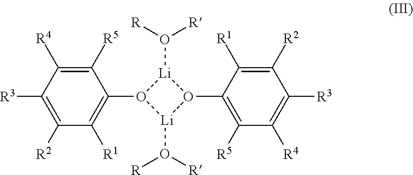

wherein the R¹ to R⁵ are as defined above and R and R′ are as defined above.

Particularly, the R¹, R⁵ and R³ may represent a trifluoromethyl group, R² and R⁴ may represent a hydrogen atom and R and R′ may represent an ethyl group.

The complexes of the invention have good electric conductivity. Therefore, it is quite natural that they are used in the electrolytic compositions of the invention.

As examples of carbonate solvents, mention may be made of ethylene carbonate, propylene carbonate or further all linear carbonates of formula R—O—(C═O)—O—R′, with R and R′ being independently of each other an alkyl group comprising from 2 to 4 carbon atoms, such as dimethyl carbonate, and mixtures thereof.

As mixtures of suitable carbonate solvents, mention may be made of a mixture comprising ethylene carbonate, propylene carbonate and dimethyl carbonate.

Specific compositions and in accordance with the invention are compositions comprising:
at least one coordination complex of the following formula (IV):

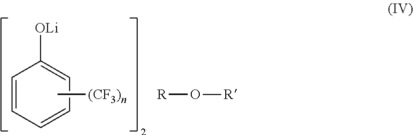

wherein:
*n is an integer ranging from 1 to 3; and
*R and R′ are as defined above; and
at least one carbonate solvent.

More specifically:
when n=1, the group —CF₃ may be located in the meta position;
when n=2, the groups —CF₃ may be located in the meta position; and
when n=3, the groups —CF₃ may be located in the ortho or para position.

The lithium complexes may be manufactured by reaction of a phenol compound comprising at least one trifluoromethyl group with an organo-lithiated compound, in particular an alkyllithium compound, like n-butyllithium, this reaction being conventionally carried out in a medium comprising an ether compound.

As an example, this reaction may be illustrated by the following reaction scheme:

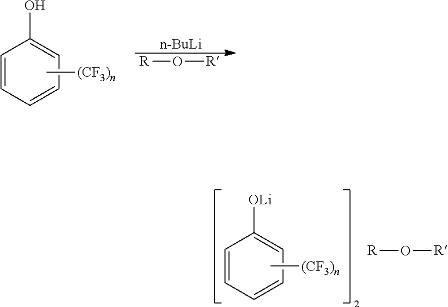

This reaction is conventionally carried out in an anhydrous medium and under an inert atmosphere for a relatively short reaction time, for example a reaction time of less than 3 hours. The reactivity of the alkyllithium compounds towards compounds derived from phenol as illustrated above, allows complete conversion of the starting reagents. Thus, advantageously, the starting reagents (compounds derived from phenol and alkyllithium compound) are used in a stoichiometric amount, which may allow simplification of the end of the reaction of the treatment for purification of the obtained product, which may be summarized by simple evaporation of the volatile substances, such as butane (generated when n-butyllithium is used).

The electrolytic compositions of the invention are advantageously intended for entering the constitution of lithium batteries and more specifically of lithium-ion batteries.

Thus, the invention also relates to a lithium battery comprising at least one electrochemical cell comprising an electrolyte positioned between a positive electrode and a negative electrode, said electrolyte comprising an electrolytic composition as defined above.

In the lithium battery, the aforementioned electrolyte may be caused in electrochemical cells of lithium batteries to impregnate a separator, which is positioned between the positive electrode and negative electrode of the electrochemical cell.

This separator may be in a porous material, such as a polymeric material, able to receive in its porosity the liquid electrolyte. More specifically, this may be a membrane of the Celguard 2400 type.

By positive electrode is conventionally meant, in the foregoing and in the following, the electrode which acts as a cathode, when the generator outputs current (i.e., when it is in a discharging process) and which acts as an anode when the generator is in a charging process.

By negative electrode, is conventionally meant, in the foregoing and in the following, the electrode which acts as an anode, when the generator outputs current (i.e., when it is in a discharging process) and which acts as a cathode, when the generator is in a charging process.

Advantageously, the negative electrode may be based on a lithiated titanium oxide, such as Li₄Ti₅O₁₂, which forms the lithium insertion material, which oxide may be dispersed in a polymeric binder, for example, in a polyvinylidene fluoride binder.

The positive electrode, as for it, may be based on a lithiated transition metal oxide (the metal may for example be nickel, manganese), more specifically LiMn_{2-z}Ni₂O₄ (with 0<z<2), which oxide may be dispersed in a polymeric binder, for example, in a polyvinylidene fluoride binder.

Whether this is for the negative electrode or the positive electrode, each of them is advantageously associated with a metal current collector, for example a current collector in aluminium.

Other characteristics and advantages of the invention will become apparent from the additional description which follows which relates to examples for preparation of complexes according to the invention.

Of course, this description addition is only given as an illustration of the invention and by no means as a limitation thereof.

### DETAILED DISCUSSION OF PARTICULAR EMBODIMENTS

### Example 1

This example illustrates the preparation of a lithium complex in an ether medium, this preparation may be illustrated by the following reaction scheme:

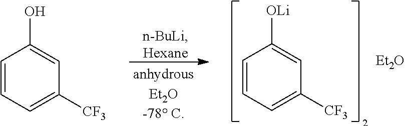

In a 50 mL flask provided with a magnetic stirrer and a septum, dried with a flame and purged with argon, are introduced with a syringe, 10 mL of anhydrous diethyl ether and 2.59 g (16 mmol) of 3-trifluoromethylphenol. The resulting solution is homogenized by stirring and cooled to −78° C. by inserting the flask into an ethanol/N₂ mixture. 10 mL of a 1.6 M n-butyllithium solution in hexane are delicately introduced within 5 minutes, via a syringe. Once the addition is completed, the mixture is stirred at room temperature for 3 hours. At the end of the reaction, the limpid mixture is evaporated in vacuo in order to remove the solvent and the volatile compounds generated during the synthesis. The complex illustrated in the reaction scheme above is obtained in the form of a white solid. The latter is conditioned under an inert atmosphere, i.e. argon.

The yield is greater than 95%.

The obtained solid was analyzed by ¹H NMR (DMSO) and RMN ¹³C NMR (DMSO).

The results are the following.

¹H NMR (DMSO): 1.12 (t, 6H); 3.39 (q, 4H); 6.43 (d, 2H); 6.66 (d, 2H); 6.73 (s, 2H); 7.03 (t, 2H).

¹³C NMR (DMSO): 15.5; 65.4; 106.3; 115.8; 123.7; 125.8 (q, J=270 Hz); 129.3; 130.0 (q, J=30 Hz); 170.1.

### Example 2

This example illustrates the preparation of a lithium complex in an ether medium, this preparation may be illustrated by the following reaction scheme:

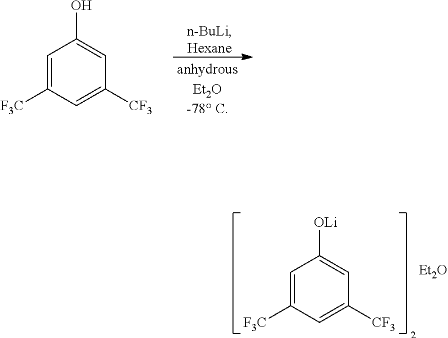

In a 50 mL flask provided with a magnetic stirrer and a septum, dried with a flame and purged with argon, are introduced, with a syringe, 10 mL of anhydrous diethyl ether and 3.68 g (16 mmol) of 3,5-bis(trifluoromethyl)phenol. The resulting solution is homogenized by stirring and cooled to −78° C. by inserting the flask in an ethanol/N₂ mixture. 10 mL of a 1.6 M n-butyllithium solution in hexane are delicately introduced, within 5 minutes, via a syringe. Once the addition is completed, the mixture is stirred at room temperature for 3 hours. At the end of the reaction, the limpid mixture is evaporated in vacuo in order to remove the solvents and the volatile components generated during synthesis. The complex illustrated in the reaction scheme above is obtained in the form of a white solid. The latter is conditioned under an inert atmosphere, i.e. argon.

The yield is greater than 87%.

The obtained solid was analysed by ¹H NMR (DMSO) and ¹³C NMR (DMSO).

The results are the following.

¹H NMR (DMSO): 1.10 (t, 6H); 3.40 (q, 4H); 6.65 (s, 2H); 6.93 (s, 4H).

¹³C NMR (DMSO): 15.2; 65.2; 101.7; 119.3; 125.0 (q, J=272 Hz); 131.0 (q, J=30 Hz); 170.7.

### Example 3

This example illustrates preparation of a lithium complex in an ether medium, this preparation may be illustrated by the following reaction scheme:

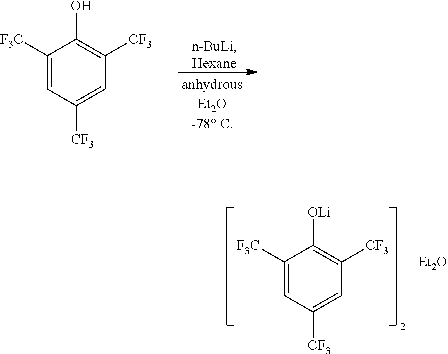

In a 50 mL flask provided with a magnetic stirrer and a septum, dried with a flame and purged with argon, are introduced, with a syringe, 10 mL of anhydrous diethyl ether and 4.77 g (16 mmol) of 2,4,6-tris(trifluoromethyl)phenol. The resulting solution is homogenized by stirring and cooled to −78° C. by inserting the flask in an ethanol/N₂ mixture. 10 mL of a 1.6 M n-butyllithium solution in hexane are delicately introduced, within 5 minutes, via a syringe. Once the addition is completed, the mixture is stirred at room temperature for 3 hours. At the end of the reaction, the limpid mixture is evaporated in vacuo in order to remove the solvents and the volatile compounds generated during the synthesis. The complex illustrated in the reaction scheme above is obtained in the form of a white solid. The latter is conditioned under an inert atmosphere, i.e. argon.

The yield is greater than 87%.

The obtained solid was analysed by ¹H NMR (DMSO) and ¹³C NMR (DMSO).

The results are the following.

¹H NMR (DMSO): 1.07 (t, 6H); 3.34 (q, 4H); 7.52 (s, 4H).

¹³C NMR (DMSO): 15.7; 65.4; 79.7; 102.0 (q, J=32 Hz); 119.2 (q, J=27 Hz); 125.7 (q, J=272 Hz); 121.6 (q, J=272 Hz); 169.8.

### Example 4

This example has the goal of determining the conductivity of compositions according to the invention comprising lithium complexes prepared according to the previous examples.

To do this, a mixture of carbonate solvents consisting of 20% by mass of ethylene carbonate, of 20% by mass of propylene carbonate and of 60% by mass of dimethyl carbonate is prepared beforehand. To this mixture are added 3 millimoles of complexes prepared according to the aforementioned Examples 1 to 3, in return for which an electrolyte is obtained (designated as electrolyte 1, electrolyte 2 and electrolyte 3 respectively).

The conductivity of the three electrolytes obtained was measured at 20° C. The results are shown in the table below.

| | Conductivity at 20° C. |
|---|---|
| Electrolyte | (in mS/cm) |
| 1 | 0.1 |
| 2 | 0.33 |
| 3 | 1.1 |

1-9. (canceled)

10. An electrolytic composition comprising:
at least one coordination complex comprising lithium and one or more ligands thereof, said one or more ligands corresponding to a phenate compound comprising at least one trifluoromethyl group; and
at least one carbonate solvent.

11. The composition according to claim 10, wherein the at least one coordination complex further comprises a compound belonging to the family of ethers.

12. The composition according to claim 11, wherein said compound belonging to the family of ethers is a compound fitting the following general formula (II):
R—O—R′ (II)
wherein R and R′ represent, independently of each other, a hydrocarbon group comprising from 2 to 4 carbon atoms.

13. The composition according to claim 11, wherein said compound belonging to the family of ethers is diethyl ether.

14. The composition according to claim 10, wherein the phenate compound fits the following formula (I): 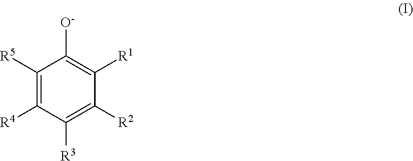
wherein at least one of R¹ to R⁵ represents a trifluoromethyl group, while the other groups where they do not represent a trifluoromethyl group, represent a hydrogen atom.

15. The composition according to claim 10, wherein said phenate compound is a 3-trifluoromethylphenate compound, a 3,5-bis (trifluoromethyl) phenate compound, or a 2,4,6-tris (trifluoromethyl) phenate compound.

16. The composition according to claim 10, wherein the at least one coordination complex fits the following formula (III): 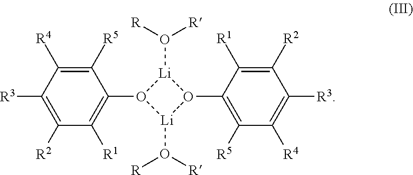
wherein R¹ to R⁵ are as defined in claim 15 and R and R′ represent, independently of each other, a hydrocarbon group, for example an alkyl group comprising from 2 to 4 carbon atoms.

17. The composition according to claim 16, wherein R¹, R⁵, and R³ represent a trifluoromethyl group, R² and R⁴ represent a hydrogen atom, and R and R′ represent an ethyl group.

18. A lithium battery comprising:
at least one electrochemical cell comprising an electrolyte positioned between a positive electrode and a negative electrode, said electrolyte comprising an electrolytic composition comprising
at least one coordination complex comprising lithium and one or more ligands thereof, said one or more ligands corresponding to a phenate compound comprising at least one trifluoromethyl group; and
at least one carbonate solvent.
